(19) United States
(12) Patent Application Publication
(10) Pub. No.: US 2011/0044068 A1
(43) Pub. Date: Feb. 24, 2011

(54) TIRE WITH ILLUMINATION DEVICE

(76) Inventor: Lee Falica, Davidsonville, MD (US)

Correspondence Address: TR Patents, L.L.C., 10351 Southern MD BLVD Suite 102, P.O Box 361, Dunkirk, MD, 20754, US

(21) Appl. No.: 12/818,062

(22) Filed: Jun. 17, 2010

Related U.S. Application Data
(60) Provisional application No. 61/268,911, filed on Jun. 18, 2009.

(51) Int. Cl. F21V 33/00; B23P 19/00

(52) U.S. Cl. 362/549; 29/426.2

(57) ABSTRACT

A device is provided for use with a wheel having an outer radius. The device includes a translucent annulus and a light source. The translucent annulus has an inner radial surface for surrounding the wheel such that the inner radial surface contacts the outer radius. The light source is disposed within the translucent annulus and can emit light into the translucent annulus.

The present application claims priority from U.S. Provisional Application No. 61/268,911 filed Jun. 18, 2009, the entire disclosure of which is incorporated herein by reference.

### BACKGROUND

Many different types of devices and methods have been developed for illuminating wheeled products for safety and aesthetics. Illumination devices enable others to more easily recognize the presence of the wheeled devices in low or no light environments. Easier recognition of a wheeled device reduces the likelihood of collisions. Non-limiting examples of wheeled devices include horse-carts, farm equipment, buses, bicycles, strollers, skate boards, roller skates, roller blades, motorcycles and automobiles. Non-limiting examples of illumination devices that have been developed for attachment to wheeled devices include, but are not limited to, light reflectors, lanterns, incandescent and flourescent lights and phosphorescent devices.

Illuminating devices have been attached to wheeled devices in many different ways. Reflectors have been placed on the front, rear and sides of wheeled devices. Reflectors have been configured on foot pedals and operator clothing. Light emitting devices have been developed for attachment to the frames of wheeled devices as well as the valve stem of pressurized tubes. Reflective paint has been used in order to provide enhanced visibility of wheeled devices.

Conventional methods of enhancing illumination of wheeled devices have drawbacks. It can be difficult to find a location to mount reflectors and electrical lights on wheeled devices. Reflectors increase weight and are easily damaged from collisions. Electrical lights are also fairly expensive, and require frequent repair. Phosphorescent devices have a limited timeframe for use and require frequent recharging or replacement, which requires a significant amount of recurring effort and expense. Reflective paints provide generally acceptable illumination when illuminated with direct light, but less than adequate illumination in ambient light.

What is needed is a system and method for providing illumination for a wheel, wherein the illumination is convenient and theft resistant.

### BRIEF SUMMARY

The present invention is drawn to a system and method for providing illumination for a wheel, wherein the illumination is convenient and theft resistant.

In accordance with an aspect of the present invention, a device is provided for use with a wheel having an outer radius. The device includes a translucent annulus and a light source. The translucent annulus has an inner radial surface for surrounding the wheel such that the inner radial surface contacts the outer radius. The light source is disposed within the translucent annulus and can emit light into the translucent annulus.

In accordance with another aspect of the present invention, a method includes: disposing a spacer on a cylindrical rim; forming a translucent annulus around the cylindrical rim so as to cover the spacer; removing the translucent annulus and covered spacer from the cylindrical rim; removing the covered spacer from the translucent annulus to provide a space within the translucent annulus; and disposing a light source into the space within the translucent annulus.

In accordance with another aspect of the present invention, a method comprises: forming a translucent annulus around a cylindrical rim; disposing a spacer within the translucent annulus; removing the translucent annulus and spacer from the cylindrical rim; removing the spacer from the translucent annulus to provide a space within the translucent annulus; and disposing a light source into the space within the translucent annulus.

Additional advantages and novel features of the invention are set forth in part in the description which follows, and in part will become apparent to those skilled in the art upon examination of the following or may be learned by practice of the invention. The advantages of the invention may be realized and attained by means of the instrumentalities and combinations particularly pointed out in the appended claims.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates an example wheel assembly with a light source attached to or located adjacent to a wheel rim, in accordance with an aspect of the present invention;

FIG. 2 illustrates a cross-sectional side-view of wheel assembly of FIG. 1;

FIG. 3 illustrates a cross-sectional side-view of a modified wheel assembly of FIG. 1, with a light source located near the center of a translucent annulus, in accordance with an aspect of the present invention;

FIG. 4 illustrates a cross-sectional side-view of modified wheel assembly of FIG. 1, in accordance with an aspect of the present invention;

FIG. 5 illustrates an example modified wheel assembly of FIG. 4, with a light source located near the center of a translucent annulus, in accordance with an aspect of the present invention;

FIG. 6 illustrates an example modified wheel assembly of FIG. 4, with a light source located near the outer radius of a translucent annulus, in accordance with an aspect of the present invention;

FIG. 7 illustrates an example light assembly for transmission of light as controlled by a sensor, in accordance with an aspect of the present invention;

FIG. 8 illustrates an example light assembly with a switch for controlling the on/off state, in accordance with an aspect of the present invention;

FIG. 9 illustrates an example light assembly of FIG. 7, with the addition of a threshold detector, in accordance with an aspect of the present invention;

FIG. 10 illustrates an example light assembly of FIG. 7, with the addition of a timing controller, in accordance with an aspect of the present invention;

FIG. 11 illustrates an example light assembly of FIG. 7, with the addition of a switch, threshold detector and timing controller, in accordance with an aspect of the present invention;

FIG. 12 illustrates an example bicycle assembly with an example application a light assembly of FIG. 11, in accordance with an aspect of the present invention;

FIG. 13 illustrates an example stroller assembly with an example application a light assembly of FIG. 8 or FIG. 11, in accordance with an aspect of the present invention;

FIGS. 14A-G illustrate an example method for constructing a translucent annulus with an embedded light source as illustrated in FIG. 2, in accordance with an aspect of the present invention;

FIG. 15 illustrates an example method using the elements of FIGS. 14A-G, for constructing a translucent annulus with an embedded light source in accordance with an aspect of the present invention;

FIGS. 16A-G illustrate an example method for constructing a translucent annulus with an embedded light source as illustrated in FIG. 3, in accordance with an aspect of the present invention;

FIG. 17 illustrates an example embodiment of the present invention with a plurality of light sources; and

FIG. 18 illustrates another example wheel assembly in accordance with an aspect of the present invention.

### DETAILED DESCRIPTION

In accordance with an example aspect of the present invention, a tire is provided for use with a wheel. The tire includes a translucent annulus having a light source therein. The translucent annulus surrounds the wheel and the light source emits light so that the tire glows. In some embodiments, the wheel may be a wheel rim, wherein the translucent annulus having a light source therein is disposed directly on the wheel rim. In other embodiments, the wheel may be an inflatable inner tube, wherein the translucent annulus having a light source therein is disposed on the inflatable inner tube.

A wheel in accordance with an aspect of the present invention may be used with a bicycle. For example, a wheel in accordance with an aspect of the present invention may illuminate in darkness as a beacon to others. In accordance with another aspect of the present invention, a wheel may be prevented from illuminating during the day when the bicycle may already be easily seen, in order to save power. In accordance with another aspect of the present invention, a wheel may be illuminated by multiple light sources. In accordance with another aspect of the present invention, a wheel may be continuously or periodically illuminated.

In accordance with another aspect of the present invention, a wheel may include a power source to provide power for illumination. In accordance with another aspect of the present invention, a wheel may include a single annulus or multiple annuluses. In accordance with another aspect of the present invention, a light source may emit light that is the the same or different color from the translucent annulus.

Sensors may be disposed within translucent annulus for detecting various parameters. Non-limiting examples of these parameters include pressure, motion, velocity, acceleration and illumination. A measurement of a parameter by a sensor, may determine whether a light source is to be illuminated or not illuminated.

A threshold detector may be included for further processing of information from a sensor. For example, presume that a person is walking a bicycle as opposed to riding the bicycle. For this example, the threshold detector may differentiate between a bicycle moving at a walking speed, which may indicate a likelihood that a person is walking the bike, versus a bicycle moving at faster speed, which may indicate a likelihood that the person is riding the bicycle. Furthermore, for this example, the threshold detector may disable the light source when the measured velocity is less than walking speed, and may activate the light source when the measured velocity is greater than walking speed.

A timing controller may be included for controlling the time of illumination of the light source. Even though a sensor may measure and indicate a condition for continuous illumination, a timing controller may enable the light source to illuminate for a predetermined period of time, or degrees of rotation. An increased illumination time allows for a larger footprint of illumination as the light source rotates about the center of the wheel.

A switch may be included for enabling/disabling the light source. The switch may disable operation of a light source during times when it is desirable to prevent illumination of the light source. Take for example, an embodiment of the present invention that includes a wheel having a translucent annulus, a light source within the translucent annulus and a pressure sensor for activating illumination of a light source. Suppose, in this example, that the wheel is disposed such that the pressure sensor detects pressure, such as from packaging or from being displayed on a store shelf. In this example, the pressure sensor may enable the light source to emit light, even though the wheel may be packed in a box or sitting on a shelf. The switch may prevent illumination of the light source during such times to save power.

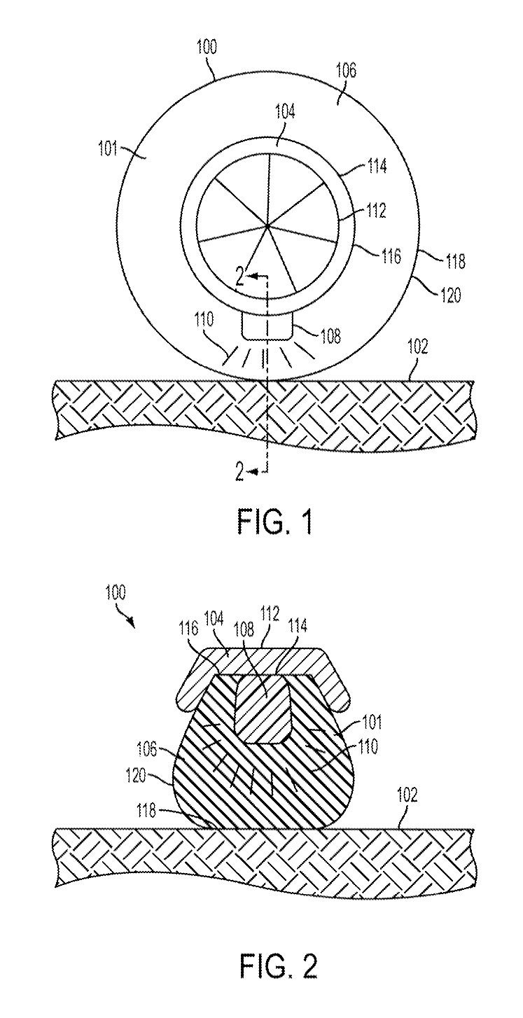

Example aspects of the present invention will now be described in greater detail with reference to FIG. 1 through FIG. 17.

Example wheel assemblies in accordance with aspects of the present invention will first be described with reference to FIGS. 1-6.

FIG. 1 illustrates an example wheel assembly 100 with a light source, in accordance with an aspect of the present invention.

Wheel assembly 100 includes a wheel rim 104 and a tire 101. Wheel rim 104 has an inner radius 112 and an outer radius 114. Tire 101 has a translucent annulus 106 and a light source 108. Translucent annulus 106 has an inner radius 116 and a periphery 118, which includes an outer radius 120.

Tire 101 is mounted onto wheel rim 104 such that inner radius 116 of translucent annulus 106 contacts outer radius 114 of wheel rim 104. In this example, light source 108 is adjacent to wheel rim 104. Outer radius 120 of translucent annulus 106 makes contact with and resides on top of a ground surface 102.

Light source 108 is operable to emit a light 110. Light 110 may be any predetermined color, i.e., frequency, frequency band or combination of frequencies. Translucent annulus may be clear or have a predetermined color. In some embodiments, light 110 is the same color as translucent annulus 106. In other embodiments, light 110 is a different color as translucent annulus 106. Since translucent annulus 106 is translucent, light 110 traverses through translucent annulus 106 and eventually out through periphery 118. Light 110 may then be seen to indicate a presence of wheel assembly 100, and hence an associated wheeled device. Light 110 may be white or may be a predetermined color.

Wheel assembly 100 will now be further described with reference to FIG. 2. FIG. 2 illustrates a cross-sectional view of wheel assembly 100. As illustrated in the figure, light source 108 is disposed adjacent to outer radius 114 of wheel rim 104.

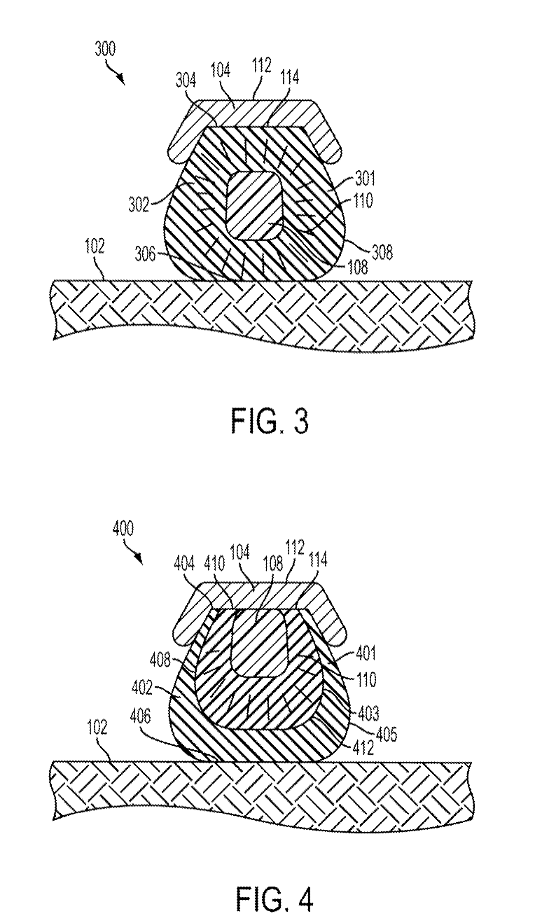

In other embodiments in accordance with the present invention, a light source is not disposed adjacent to wheel rim 104. Another example embodiment will now be described with reference to FIG. 3.

FIG. 3 illustrates a cross-sectional view of an example wheel assembly 300 in accordance with an aspect of the present invention.

As illustrated in the figure, wheel assembly 300 includes wheel rim 104 and a tire 301. Tire 301 has a translucent annulus 302 and light source 108. Translucent annulus 302 has an inner radius 304 and a periphery 306, which includes an outer radius 308.

Tire 301 is mounted onto wheel rim 104 such that inner radius 304 of translucent annulus 302 contacts outer radius 114 of wheel rim 104. In contrast to the example embodiment discussed above with reference to FIG. 2, in this example, light source 108 is not adjacent to wheel rim 104. In this example, light source 108 is disposed within translucent annulus 302, between inner radius 304 and periphery 306. Outer radius 308 of translucent annulus 302 makes contact with and resides on top of ground surface 102.

In some embodiments, light 110 is the same color as translucent annulus 302. In other embodiments, light 110 is a different color. Since translucent annulus 302 is translucent, light 110 traverses through translucent annulus 302 and eventually out through periphery 306. Light 110 may then be seen to indicate a presence of wheel assembly 300, and hence an associated wheeled device.

Some differences between the example embodiments discussed above with reference to FIG. 2 and FIG. 3 will now be discussed.

As illustrated in FIG. 2, light source 108 is disposed adjacent to the outer radius 114 of wheel rim 104. Disposition of light source 108 in close proximity to wheel rim 104 provides a structure lending itself for ease of manufacturing an assembly composed of the combination of wheel rim 104 and light source 108, which will be discussed in more detail below. Non-limiting example methods for providing a combination of light source 108 and wheel rim 104 include fastening, gluing, heating and soldering. Furthermore, this configuration provides for ease of connecting and routing electrical connections (not shown) to light source 108. Electrical connections to light source 108 may easily be routed through holes or openings (not shown) in wheel rim 104 for connection to other components of the assembly.

As illustrated in FIG. 3, light source 108 is disposed within translucent annulus 302 between inner radius 304 and outer radius 308 of translucent annulus 302. Disposition of light source 108 in this manner provides enhanced transmission of light 110 over the transmission of light 110 as compared with the example embodiment of FIG. 2. The enhanced transmission of light 110 in FIG. 3 over that of FIG. 2 is a result of light which is absorbed or blocked by wheel rim 104 in the configuration of FIG. 2. Conversely, in FIG. 3 a smaller amount of light 110 is absorbed or blocked by wheel rim 104 thus enabling the transmission of a larger amount of light 110 through periphery 306.

In other embodiments in accordance with the present invention, a tire includes a plurality of annuluses. Another example embodiment will now be described with reference to FIG. 4.

FIG. 4 illustrates a cross-sectional view of an example wheel assembly 400 in accordance with an aspect of the present invention.

As illustrated in the figure, wheel assembly 400 includes wheel rim 104 and a tire 401. Tire 401 has an inner translucent annulus portion 408, an outer translucent annulus portion 402 and light source 108. Inner translucent annulus portion 408 has an inner radial surface 410 and a peripheral surface 412. Outer translucent annulus portion 402 has an inner radius 404, an inner peripheral surface 403 and an outer peripheral surface 405, which includes an outer radius 406.

Tire 301 is mounted onto wheel rim 104 such that inner radial surface 410 of inner translucent annulus portion 408 contacts outer radius 114 of wheel rim 104 and inner radius 404 of outer translucent annulus portion 402 contacts outer radius 114 of wheel rim 104. In this example, light source 108 is adjacent to wheel rim 104. Inner peripheral surface 403 of outer translucent annulus portion 402 makes contact with peripheral surface 412 of inner translucent annulus portion 408. Outer radius 406 of outer translucent annulus portion 402 makes contact with and resides on top of ground surface 102.

In some embodiments, light 110 is the same color as inner translucent annulus portion 408. In other embodiments, light 110 is a different color as inner translucent annulus portion 408. Since inner translucent annulus portion 408 is translucent, light 110 traverses through inner translucent annulus portion 408 and eventually out through peripheral surface 412. Since outer translucent annulus portion 402 is translucent, light 110 may then traverse through outer translucent annulus portion 402 and eventually out through outer peripheral surface 405. Light 110 may then be seen to indicate a presence of wheel assembly 400, and hence an associated wheeled device.

In some embodiments, light 110 is the same color as outer translucent annulus portion 402. In other embodiments, light 110 is a different color as outer translucent annulus portion 402.

In some embodiments, inner translucent annulus portion 408 is the same color as outer translucent annulus portion 402. In other embodiments, inner translucent annulus portion 408 is a different color from the color of outer translucent annulus portion 402.

In some embodiments, inner translucent annulus portion 408 is clear, whereas outer translucent annulus portion 402 is colored. In other embodiments, inner translucent annulus portion 408 is colored, whereas as outer translucent annulus portion 402 is clear.

Some differences between the example embodiments discussed above with reference to FIGS. 2-4 will now be discussed.

The configuration of FIG. 4, wherein tire 401 includes inner translucent annulus portion 408 and outer translucent annulus portion 402, enables repair and replacement of faulty or damaged components. For example, consider a situation where outer translucent annulus portion 402 has been damaged or worn as a result of repeated contact with ground surface 102. In this embodiment, outer translucent annulus portion 402 may be replaced or repaired without disturbing inner translucent annulus portion 408, resulting in decreased maintenance and repair costs. Furthermore, consider a situation where inner translucent annulus portion 408 containing light source 108 is damaged and requires replacement. In this embodiment, the original outer translucent annulus portion 402 may be reinstalled on wheel assembly 400 following the replacement of inner translucent annulus portion 408 and light source 108. This configuration provides for reduced maintenance and replacement costs associated with issues related to a damaged or worn inner translucent annulus portion 408 as a result of reusing outer translucent annulus portion 402.

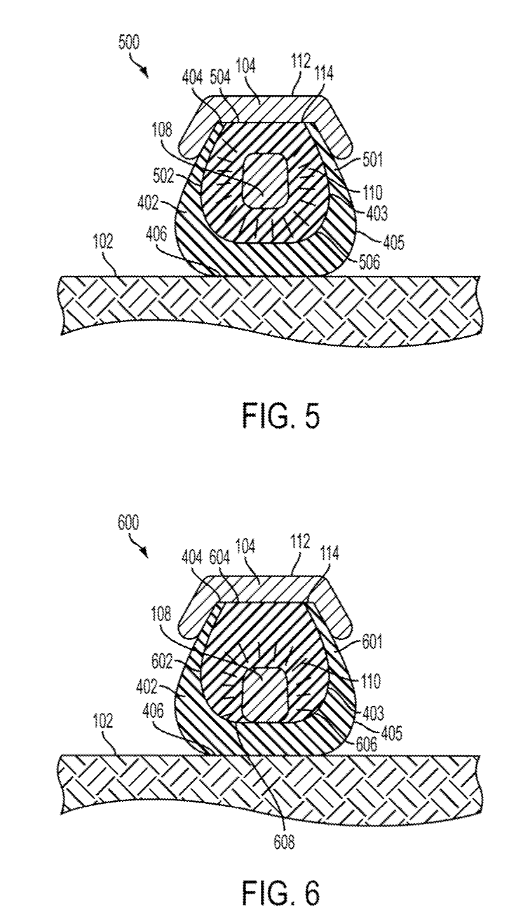

Another example embodiment will now be described with reference to FIG. 5. FIG. 5 illustrates a cross-sectional view of another example wheel assembly 500 in accordance with an aspect of the present invention.

As illustrated in the figure, wheel assembly 500 includes wheel rim 104 and a tire 501. Tire 501 has an inner translucent annulus portion 502, outer translucent annulus portion 402 and light source 108. Inner translucent annulus portion 502 has an inner radial surface 504 and a peripheral surface 506.

Tire 501 is mounted onto wheel rim 104 such that inner radial surface 504 of inner translucent annulus portion 502 contacts outer radius 114 of wheel rim 104. In contrast to the example embodiment discussed above with reference to FIG. 4, in this example, light source 108 is not adjacent to wheel rim 104. In this example, light source 108 is disposed within inner translucent annulus portion 502, between inner radial surface 504 and peripheral surface 506. Inner peripheral surface 403 of outer translucent annulus portion 402 makes contact with peripheral surface 506 of inner translucent annulus portion 502. Outer radius 406 of outer translucent annulus portion 402 makes contact with and resides on top of ground surface 102.

In some embodiments, light 110 is the same color as inner translucent annulus portion 502. In other embodiments, light 110 is a different color as inner translucent annulus portion 502. Since inner translucent annulus portion 502 is translucent, light 110 traverses through inner translucent annulus portion 502 and eventually out through peripheral surface 506. Since outer translucent annulus portion 402 is translucent, light 110 may then traverse through outer translucent annulus portion 402 and eventually out through outer peripheral surface 405. Light 110 may then be seen to indicate a presence of wheel assembly 500, and hence an associated wheeled device.

In some embodiments, inner translucent annulus portion 502 is the same color as outer translucent annulus portion 402. In other embodiments, inner translucent annulus portion 502 is a different color from the color of outer translucent annulus portion 402.

In some embodiments, inner translucent annulus portion 502 is clear, whereas outer translucent annulus portion 402 is colored. In other embodiments, inner translucent annulus portion 502 is colored, whereas outer translucent annulus portion 402 is clear.

Some differences between the example embodiments discussed above with reference FIGS. 4-5 will now be discussed.

As illustrated in FIG. 4, light source 108 is disposed adjacent to the outer radius 114 of wheel rim 104. Disposition of light source 108 in close proximity to wheel rim 104 provides a structure lending itself to ease of manufacturing an assembly composed of the combination of wheel rim 104 and light source 108. Non-limiting examples for ease-of-manufacturing processes of combining light source 108 and wheel rim 104 include fastening, gluing, heating and soldering. Furthermore, this configuration provides for ease of connecting and routing electrical connections (not shown) to light source 108. Electrical connections to light source 108 may easily be routed through holes or openings (not shown) in wheel rim 104 for connection to other components of the assembly.

As illustrated in FIG. 5, light source 108 is disposed within inner translucent annulus portion 502 between inner radial surface 504 and peripheral surface 506 of inner translucent annulus portion 502. Disposition of light source 108 in this manner provides enhanced transmission of light 110 over the transmission of light 110 as configured in FIG. 4. The enhanced transmission of light 110 in FIG. 5 over that of FIG. 4 is a result of light which is absorbed or blocked by wheel rim 104 in the configuration of FIG. 4. Conversely, in FIG. 5 a smaller amount of light 110 is absorbed or blocked by wheel rim 104 thus enabling the transmission of a larger amount of light 110 through peripheral surface 506.

Another example embodiment will now be described with reference to FIG. 6. FIG. 6 illustrates a cross-sectional view of another example wheel assembly 600 in accordance with an aspect of the present invention.

As illustrated in the figure, wheel assembly 600 includes wheel rim 104 and a tire 601. Tire 601 has an inner translucent annulus portion 602, outer translucent annulus portion 402 and light source 108. Inner translucent annulus portion 602 has an inner radial surface 604, an outer radial surface 608 and a peripheral surface 606.

Tire 601 is mounted onto wheel rim 104 such that inner radial surface 604 of inner translucent annulus portion 602 contacts outer radius 114 of wheel rim 104. In contrast to the example embodiment discussed above with reference to FIG. 4, in this example, light source 108 is not adjacent to wheel rim 104. In contrast to the example embodiment discussed above with reference to FIG. 5, in this example, light source 108 is not is disposed between the inner radial surface and peripheral surface of the inner annulus portion. In this example, light source 108 is disposed adjacent to peripheral surface 606. Inner peripheral surface 403 of outer translucent annulus portion 402 makes contact with light source 108 and with peripheral surface 606 of inner translucent annulus portion 602.

In some embodiments, light 110 is the same color as inner translucent annulus portion 602. In other embodiments, light 110 is a different color as inner translucent annulus portion 602. Since inner translucent annulus portion 602 is translucent, light 110 traverses through inner translucent annulus portion 602 and eventually out through peripheral surface 606. Since outer translucent annulus portion 402 is translucent, light 110 may then traverse through outer translucent annulus portion 402 and eventually out through outer peripheral surface 405. Light 110 may then be seen to indicate a presence of wheel assembly 600, and hence an associated wheeled device.

In some embodiments, inner translucent annulus portion 602 is the same color as outer translucent annulus portion 402. In other embodiments, inner translucent annulus portion 602 is a different color from the color of outer translucent annulus portion 402.

In some embodiments, inner translucent annulus portion 602 is clear, whereas outer translucent annulus portion 402 is colored. In other embodiments, inner translucent annulus portion 602 is colored, whereas outer translucent annulus portion 402 is clear.

Differences and contrasts with respect to FIG. 4-6 will now be discussed.

As illustrated in FIG. 6, light source 108 is disposed within inner translucent annulus portion 602, adjacent to peripheral surface 606 and outer radial surface 608 of inner translucent annulus portion 602. Disposition of light source 108 in this manner provides enhanced transmission of light 110 over the transmission of light 110 as configured in FIG. 4 and FIG. 5. The enhanced transmission of light 110 in FIG. 6 over that of FIG. 4-5 is a result of light which is absorbed or blocked by wheel rim 104 in the configuration of FIG. 4-5. Conversely, in FIG. 6 a smaller amount of light 110 is absorbed or blocked by wheel rim 104 thus enabling the transmission of a larger amount of light 110 through peripheral surface 606.

There may be times when it is desirable to control the emission of light 110. For example, control of the emission of light 110 may be needed when the present invention is in a state of motion. It may be desirable to detect the state of motion and illuminate light 110 and conversely detect a state of non-motion and not provide illumination of light 110. Furthermore, it may be desirable to control the emission of light 110 based upon discrimination between two velocities, for example when the present invention is being maneuvered at the walking velocity of a person versus an operational velocity. Furthermore, it may be desirable to detect when the present invention is in a condition of daylight and provide for non-illumination of light 110. Conversely, it may be desirable to detect when the present invention is in a condition of nighttime and provide for illumination of light 110, as illumination in nighttime conditions may be desirable. Furthermore, it may be desirable to detect when the present invention is being subjected to a condition of pressure or force and provide emission of light 110. Conversely, it may be desirable to detect when the present invention is not being subject to a condition of pressure or force and not provide emission of light 110. Furthermore, it may be desirable to turn-off the capability of emission of light 110 in certain situations, for example when an embodiment of the present invention is placed on display in a retail store or when stored in a dark location. To address these situations, aspects of the present invention are drawn to example light sources.

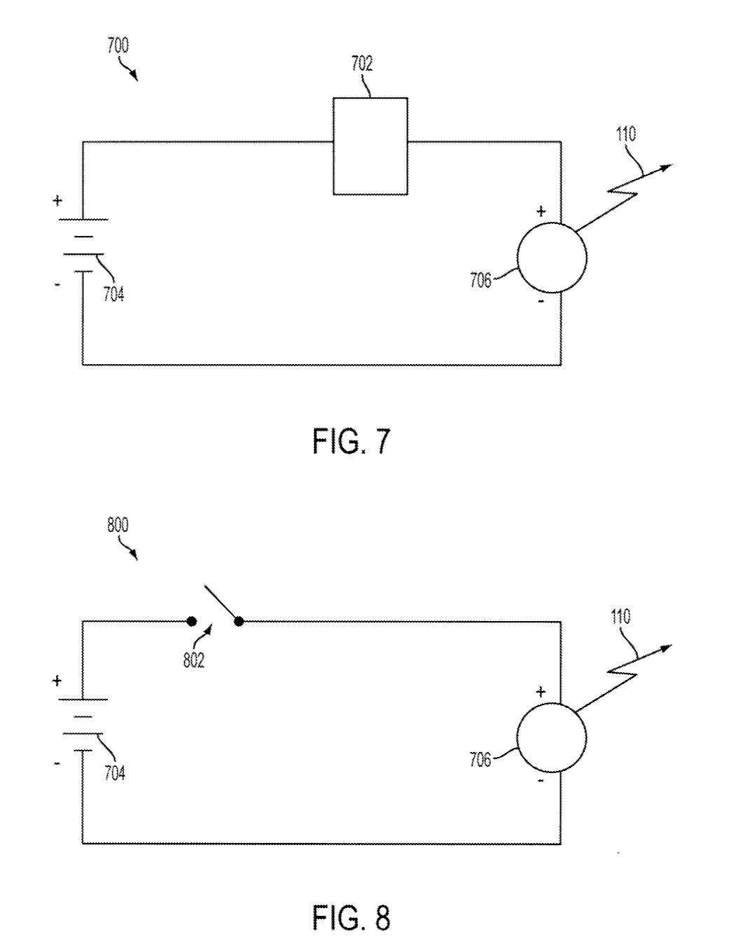

Example aspects of light sources in accordance with the present invention will now be described with reference to FIGS. 7-11.

FIG. 7 illustrates an example light assembly 700 in accordance with an aspect of the present invention.

As illustrated in the figure, light assembly 700 includes a sensor 702, a power source 704 and a light source 706. Non-limiting example types of sensor 702 include pressure sensors, motion sensors, light sensors and acceleration sensors. Non-limiting examples of types of power source 704 include batteries, solar cells and electrical generators. Non-limiting examples of light source 706 include light bulbs and Light Emitting Diodes (LEDs).

Sensor 702 is in electrical connection between power source 704 and light source 706. Light source 706 is additionally electrically connected to power source 704.

Sensor 702 is operable to sense a predetermined parameter. Non-limiting examples of parameters that sensor 702 may sense include pressure, motion, light and acceleration. Sensor 702 may be configured to sense a single parameter or sensor 702 may be configured to sense multiple parameters (e.g. pressure, motion, light and acceleration).

In some embodiments, when sensor is conducting power from power source 704 to light source 706, sensor 702 may then stop conducting power from power source 704 to light source 706 based upon sensing the predetermined parameter. For example, presume sensor 702 represents a pressure sensor. In situations where sensor 702 detects an elevated pressure condition, for example in a case where sensor 702 is within a bicycle wheel and someone is riding the bicycle, sensor 702 may conduct power from power source 704 to light source 706 enabling the transmission of light 110. Conversely, for this example, in situations where sensor 702 detects a lower pressure condition, for example in a case where sensor 702 is within a bicycle wheel and nobody is riding the bicycle, sensor would not conduct power from power source 704 to light source 706 thus preventing the transmission of light 110.

In other embodiments, when sensor is not conducting power from power source 704 to light source 706, sensor 702 may then conduct power from power source 704 to light source 706 based upon sensing the predetermined parameter. For example, presume sensor 702 represents a motion detector. In situations where sensor 702 detects a heightened motion condition, for example in a case where sensor 702 is within a bicycle wheel and the bicycle is moving quickly, sensor 702 would conduct power from power source 704 to light source 706 enabling the transmission of light 110. Conversely, for this example, in situations where sensor 702 detects a lowered motion condition, for example in a case where sensor 702 is within a bicycle and the bicycle is moving slowly (someone is walking the bicycle) or stationary, sensor 702 would not conduct power from power source 704 to light source 706 thus preventing the transmission of light 110.

In other embodiments, when sensor is conducting power from power source 704 to light source 706, sensor 702 may then stop conducting power from power source 704 to light source 706 based upon not sensing the predetermined parameter. For example, presume sensor 702 represents an illumination detector. In situations where sensor 702 detected a lowered illumination condition, for example in a case where sensor 702 is within a bicycle wheel and someone is riding the bicycle at night, sensor 702 would conduct power from power source 704 to light source 706 enabling the transmission of light 110. Conversely, for this example, in situations where sensor 702 detected a heightened illumination condition, for example in a case where sensor 702 is within a bicycle wheel and someone is riding the bicycle during the daytime, sensor would not conduct power from power source 704 to light source 706 thus inhibiting the transmission of light 110.

Consider an example application of light assembly 700, where it is desired to apply power to light source 706 and transmit light 110 when the unit light assembly 700 is in a state of operation. Furthermore, it is desired to not apply power to light source 706 and not transmit light 110 when the unit light assembly 700 is in a state of non-operation. In the operational state, sensor 702 would be configured to detect a state of operation and conduct power from power source 704 to light source 706 thus allowing the transmission of light 110. In the non-operational state, sensor would be configured to detect a state of non-operation and inhibit conduction of power from power source 704 to light source 706 thus preventing the transmission of light 110. Non-limiting examples for configurations for sensor 702 include pressure and motion.

Sensor 702 may be configured to detect a condition of elevated pressure or a condition of lessened pressure. For example, when a unit composed of light assembly 700 is in an operational state, an increased amount of pressure may be exerted on sensor 702 indicating the unit is in operation thereby providing transmission of light 110. Conversely, when a unit composed of light assembly 700 is in a state of non-operation, a decreased amount of pressure may be exerted on sensor 702 indicating a the unit is not operational and thereby prevent transmission of light 110.

Sensor 702 may be configured to detect a condition of elevated motion or a condition of lessened motion. For example, when a unit composed of light assembly 700 is in an operational state, an increased amount of velocity or acceleration may be exerted on sensor 702 indicating the unit is in operation thereby providing transmission of light 110. Conversely, when a unit composed of light assembly 700 is in a state of non-operation, a decreased amount of velocity or acceleration may be exerted on sensor 702 indicating a the unit is not operational and thereby prevent transmission of light 110.

For example, it might be desirable to detect when a bicycle is in a state of motion or when a person is resident or riding on the bicycle and transmit light 110. Conversely, it might be desirable to detect when a bicycle is not in a state of motion or when a person is not resident or riding on the bicycle and prevent the transmission of light 110.

Another example light assembly in accordance with an aspect of the present invention will now be described with reference to FIG. 8.

FIG. 8 illustrates another example light assembly 800 in accordance with an aspect of the present invention. Light assembly 800 of FIG. 8 is similar to light assembly 700 of FIG. 7, wherein sensor 702 has been replaced with a switch 802 for controlling an on/off state of light source 706.

As illustrated in FIG. 8, switch 802 is in electrical connection between power source 704 and light source 706. When switch 802 is in a closed state, power is conducted from power source 704 to light source 706, such that light source 706 emits light 110. When switch 802 is in an open state, power is not conducted from power source 704 to light source 706, such that light source 706 cannot emit light 110. Non-limiting examples of switch 802 include mechanical switches, e.g., button switches, toggle switches, Radio Frequency (RF) switches and slides switches and electronic switches, e.g. transistors.

A further discussion of example light assemblies based on the example light assembly of FIG. 7 will now be provided. For example, in an example of sensor 702 configured as a motion sensor, it may be desirable to differentiate between the velocity of a person walking (e.g. pushing a bicycle) and the velocity of bicycle in operation. Additionally, in an example of sensor 702 configured as a light sensor, it may be desirable to differentiate light illumination between day and night. For example, it may be desirable to enable operation of an embodiment during hours of nighttime and disable operation of an embodiment during hours of daylight. Furthermore, a threshold device may be added to the embodiment of FIG. 7 for increasing the discrimination capabilities of light assembly 700 with respect to its sensing capabilities (e.g. pressure, velocity, acceleration, motion and illumination) supplied by sensor 702.

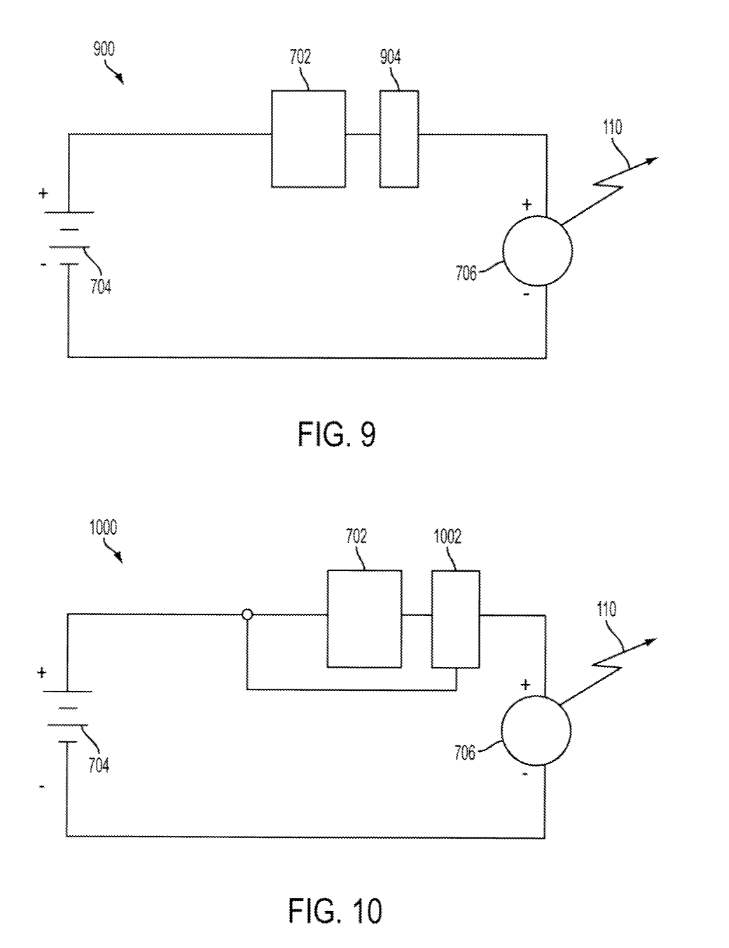

Another example light assembly in accordance with an aspect of the present invention will now be described with reference to FIG. 9.

FIG. 9 illustrates another example light assembly 900 in accordance with an aspect of the present invention. Light assembly 900 of FIG. 9 is similar to light assembly 700 of FIG. 7 with the addition of a threshold detector 904.

As illustrated in FIG. 9, threshold detector 904 is in electrical connection between sensor 702 and light source 706.

Threshold detector 904 determines whether the output of sensor 702 has reached a predetermined threshold. If the output of sensor 702 has reached the predetermined threshold, threshold detector 904 provides power to light source 706. Light source 706 is able to emit light 110 based on the power supplied from threshold detector 904. If the output of sensor 702 has not reached the predetermined threshold, threshold detector 904 does not provide power to light source 706. Light source 706 is then unable to emit light 110.

Threshold detector 904 may be any known threshold detecting device or mechanism.

A further discussion of still more example light assemblies based on the example light assembly of FIG. 7 will now be provided. Additional capabilities will now be discussed with reference to the operation of light 110. For example, it might be desirable to enable the transmission of light 110 for a specific amount or period of time. Furthermore, the period of time for the transmission of light 110 may correspond: with the velocity of a wheel; with an amount of time required for one revolution of a wheel; or with a fractional amount of time required for one revolution of a wheel. Furthermore, the amount of time for transmission of light 110 might be configured for optimizing or conserving the consumption of power supplied by power source 704. Furthermore, the amount of time for transmission of light 110 might be in relation or relative to a plurality of light sources. Furthermore, the amount of time for transmission of light 110 might be configured for aesthetic or safety concerns.

Another example light assembly in accordance with an aspect of the present invention will now be described with reference to FIG. 10.

FIG. 10 illustrates another example light assembly 1000 in accordance with an aspect of the present invention. Light assembly 1000 of FIG. 10 is similar to light assembly 700 of FIG. 7 with the addition of a timing controller 1002 and a path from power source 704 to timing controller 1002.

As illustrated in FIG. 10, timing controller 1002 is in electrical connection between sensor 702 and light source 706.

Timing controller 1002 controls the activation time of light source 706, once activated. Timing controller 1002 controls the duration for the amount of time light 110 is displayed and also controls the amount of time light 110 is not displayed. For example, sensor 702 may detect or measure a continuous parameter indicating an ON condition. However, light source 706 does not continuously transmit light 110. Instead, timing controller 1002 transfers power to light source 706 for a predetermined amount time and then subsequently timing controller 1002 does not transfer power to light source 706 for a predetermined amount of time. Timing controller 1002 may provide a reduction in power consumption, as less power is consumed by periodically transmitting light 110 instead of continuously transmitting light 110. Furthermore, timing controller 1002 may provide the capability of increasing the time period for which light 110 is transmitted, for example in the case of a short indication from sensor 702.

Timing controller 1002 may be any known time controlling device or mechanism.

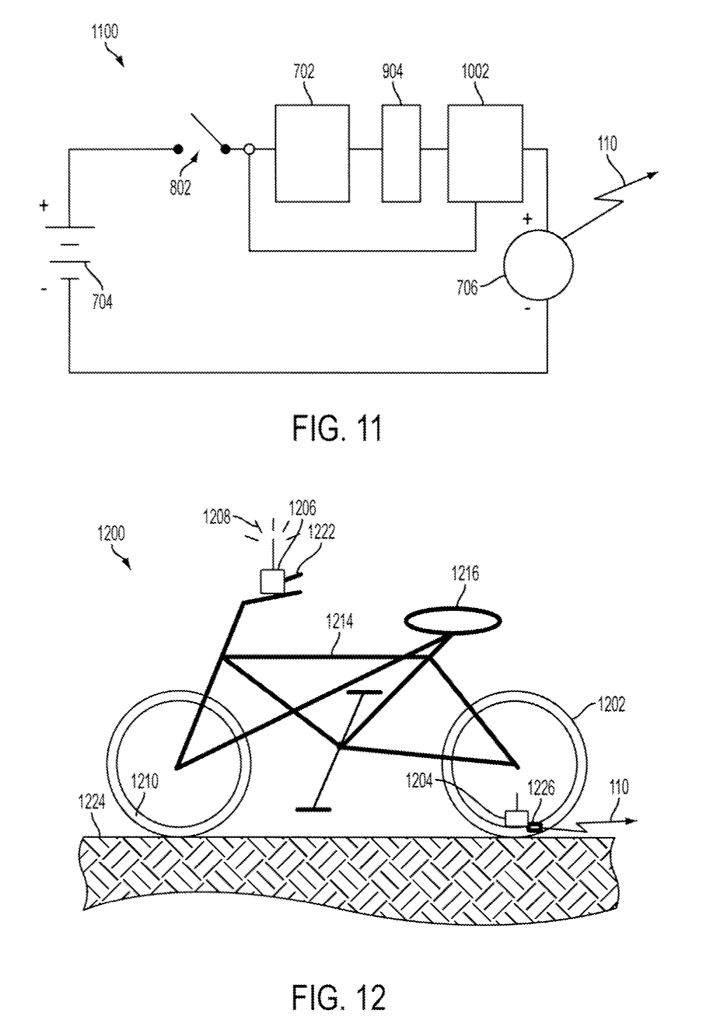

Example embodiments of light assemblies in accordance with aspects of the present invention may include portions of the example light assemblies discussed above with reference to FIGS. 7-10, or combinations thereof. One non-limiting example light assembly in accordance with the present invention that includes a combination of portions of the example light assemblies discussed above with reference to FIGS. 7-10 will now be described with reference to FIG. 11.

The example embodiment of FIG. 11 includes an incorporation of the features of FIGS. 7-10. The embodiment of FIG. 11 includes a sensor capability, as illustrated in FIG. 7, for detection of conditions (e.g. pressure, velocity, acceleration, motion and illumination) for controlling the operation of light 110. For example, it might be desirable to transmit light 110 or inhibit the transmission of light 110 when a certain pressure, velocity, acceleration, motion or illumination is detected. The embodiment of FIG. 11 includes a switching device, as illustrated in FIG. 8, for enabling or inhibiting the transmission of light 110. For example, it might be desirable to inhibit the transmission of light 110 when the present invention is contained in packaging used for shipping, as the sensing capability might detect conditions for illumination, yet the need for illumination may be undesirable. The embodiment of FIG. 11 includes a threshold detector, as illustrated in FIG. 9, for further controlling the operation of light 110. For example, it might be desirable to discriminate between a lower velocity (e.g. walking speed) and an operational velocity or to discriminate between day and night. The embodiment of FIG. 11 includes a timing controller, as illustrated in FIG. 10, for controlling the amount of time or period of time for illumination of light 110. For example, it might be desirable to control the illumination of light 110 for the optimization or conservation of power consumption or for coordination with other sources of emitted light or features.

FIG. 11 illustrates another example light assembly 1100 in accordance with an aspect of the present invention.

As illustrated in FIG. 11, light assembly 1100 includes power source 704, switch 802, sensor 702, threshold detector 904, timing controller 1002 and light source 706.

Switch 802 is in electrical connection between power source 704 and sensor 702. Sensor 702 is in electrical connection between switch 802 and threshold detector 904. Threshold detector 904 is in electrical connection between sensor 702 and timing controller 1002. Timing controller 1002 is in electrical connection between threshold detector 904 and light source 706. Timing controller 1002 is also in electrical connection between switch 802 and light source 706. Light source 706 is in electrical connection between timing controller 1002 and power source 704.

The following discussion of example applications of aspects of the present invention will further illuminate the benefits of the present invention.

FIG. 12 illustrates an example embodiment of the present invention implemented in a bicycle application where the on/off state of the emitted light is controlled by a RF switch.

FIG. 12 illustrates a bicycle 1200 with an example application of FIG. 11 of the present invention.

Bicycle 1200 includes a wheel 1202, an RF receiver 1204, an RF transmitter 1206 and a wheel 1210. One or both of wheel 1202 and wheel 1210 may be a wheel assembly in accordance with aspects of the present invention, for example as illustrated in any of FIGS. 1-6. Further, one or both of wheel 1202 and wheel 1210 may include a lighting assembly in accordance with aspects of the present invention, for example as illustrated in FIG. 8 or FIG. 11. To simplify explanation, presume in this example that wheel 1210 is a wheel assembly in accordance with aspects of the present invention as illustrated in FIG. 1 and includes a lighting assembly in accordance with aspects of the present invention as illustrated in FIG. 11.

Wheel 1202 contacts a ground surface 1224. RF receiver 1204 is connected to wheel 1202. RF receiver 1204 is electrically connected to a light source 1226. Light source 1226 transmits light 110. For the embodiment of FIG. 12, the combination of a switch 1222, RF transmitter 1206 and RF receiver 1204 correspond to switch 802 as depicted in FIG. 11. Furthermore, light source 1226 corresponds to the combination of power source 704, sensor 702, threshold detector 904, timing controller 1002 and light source 706 as depicted in FIG. 11.

Switch 1222 is connected to RF transmitter 1206. Turning switch 1222 to the ON state causes a signal indicating a transition to the ON state to be transmitted by a RF signal 1208. Turning switch 1222 to the off state causes a signal indicating a transition to the off state to be transmitted by RF signal 1208.

A person (not shown) riding bicycle 1200 may use switch 1222 to turn on or turn off transmission of light 110. When switch 1222 transitions to the ON state, RF transmitter 1206 transmits RF signal 1208 indicating an ON condition. RF signal 1208 is received by RF receiver 1204. RF receiver is then enabled to transmit a signal to light source 1226. Light source 1226 then transmits light 110.

When switch 1222 transitions to the off state, RF transmitter 1206 transmits RF signal 1208 indicating an off condition. RF signal 1208 is received by RF receiver 1204. RF receiver is then configured to cease transmitting a signal to light source 1226. Light source 1226 then ceases transmitting light 110.

When switch 1222 is in the ON state, switch 802 of FIG. 11 is also in the ON state, enabling power to be transferred through switch 802 and to sensor 702. When switch 1222 and switch 802 are in the ON state, the transmission of light 110 by light source 1226 may also be controlled by sensor 702, threshold detector 904 and timing controller 1002 as illustrated in FIG. 11. For example, when sensor 702 is represented by a pressure sensor, a person (not shown) residing on a seat 1216 would transmit a downward force on seat 1216 with said force being transmitted through a frame 1214 to sensor 702 which is disposed within light source 1226.

Sensor 702 may interpret asserted force or pressure as a condition for enabling power from power source 704 to be transferred through sensor 702 to threshold detector 904. Threshold detector 904 may determine whether a sufficient pressure threshold has been crossed. If a sufficient pressure threshold has been crossed, then power transmitted from power source 704 through switch 802 and sensor 702 would be transmitted through threshold detector 904 to timing controller 1002. Timing controller 1002 may then transfer power to light source 706 enabling the transmission of light 110.

After a predetermined amount of time, timing controller 1002 may prevent transmission of power to light source 706, which would prevent transmission of light 110. Timing controller 1002 may then prevent the transmission of power to light source 706 for a predetermined amount of time. Then, and with pressure remaining asserted on sensor 702, timing controller 1002 may enable transmission of power to light source 706 to transmit light 110. As long as sufficient pressure remains asserted on sensor 702, power may continue to be transferred through switch 802, sensor 702 and threshold detector 904 to timing controller 1002. Furthermore, the transmission of light 110 may continue to be controlled by timing controller 1002.

In a further example, consider when sensor 702 includes a motion detector and switch 1222 (and also switch 802 of FIG. 11) is in the ON state. When bicycle 1200 is not moving, sensor 702 detects the state of no motion and does not allow the transfer power to threshold detector 904 and thereby prevents the transmission of light 110. Conversely, when bicycle 1200 is moving, sensor 702 detects the state of motion and allows the transfer power to threshold detector 904. If the motion detected by sensor 702 is sufficiently large then threshold detector 904 allows the transfer of power to timing controller 1002. Timing controller 1002 may then allow the transfer of power to light source 706 and the subsequent transmission of light 110.

After an appropriate amount of time, timing controller 1002 may prevent transmission of power to light source 706, which would prevent transmission of light 110. Timing controller 1002 may then prevent the transmission of power to light source 706 for a predetermined period of time. At this point, and with a sufficient amount of motion asserted on sensor 702, timing controller 1002 may enable transmission of power to light source 706 to transmit light 110. As long as sufficient motion remained present on sensor 702, power may continue to be transferred through switch 802, sensor 702 and threshold detector 904 to timing controller 1002. Furthermore, the transmission of light 110 may continue to be controlled by timing controller 1002.

In a further example, consider when sensor 702 includes an illumination detector and switch 1222 (and also switch 802 of FIG. 11) is in the ON state. When bicycle 1200 is being operated in a state such that sensor 702 determines it is in an environment of illumination and that light 110 should not be transmitted, then sensor 702 acts to inhibit the transfer of power to threshold detector 904 and thereby inhibits the transmission of light 110. Conversely, when bicycle 1200 is in a state of illumination, sensor 702 detects the state of illumination and allows the transfer power to threshold detector 904. If the illumination detected by sensor 702 and transmitted to threshold detector 904 is of a sufficiently small quantity then threshold detector 904 allows the transfer of power to timing controller 1002, followed by timing controller 1002 allowing the transfer of power to light source 706 and the subsequent transmission of light 110. After an appropriate amount of time, timing controller 1002 may then inhibit transmission of power to light source 706, thereby inhibiting the transmission of light 110. Timing controller 1002 would then inhibit the transmission of power to light source 706 for a predetermined amount of time. Following this and with illumination of a sufficient quantity remaining asserted on sensor 702, timing controller 1002 would enable transmission of power to light source 706 enabling transmission of light 110. As long as sufficient illumination remained present on sensor 702, power would continue to be transferred through switch 802, sensor 702 and threshold detector 904 to timing controller 1002. Furthermore, the transmission of light 110 would continue to be controlled by timing controller 1002.

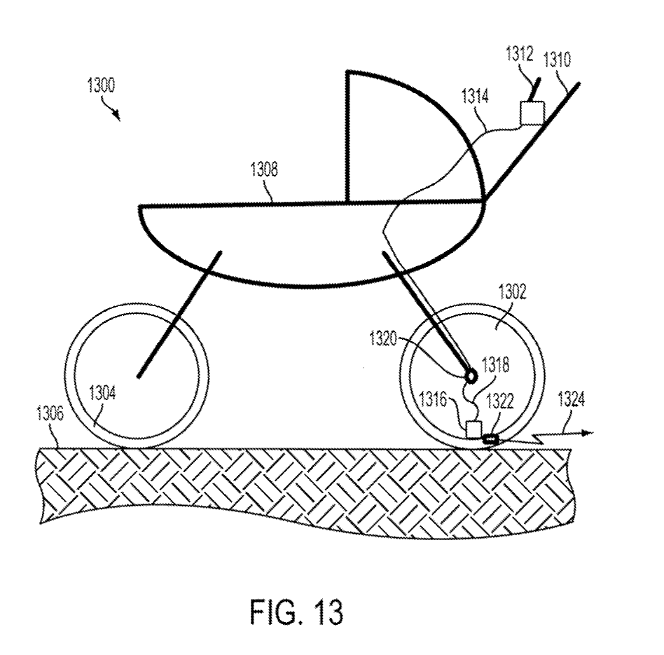

FIG. 12 illustrates an example embodiment of the present invention implemented in a bicycle application where the ON/OFF state of the emitted light is controlled by an RF switch. FIG. 13 illustrates an example embodiment of the present invention implemented in a stroller application where the on/off state of the emitted light is controlled by a hard-wired switch.

FIG. 13 illustrates a stroller assembly 1300 with an example application of FIG. 8 or FIG. 11 of the present invention.

Stroller assembly 1300 includes a wheel assembly 1302, a wheel assembly 1304, a frame 1308, a handle 1310, a switch 1312, a wire 1314, a controller 1316, a wire 1318, a coupler 1320 and a light source 1322.

Switch 1312, wire 1314, coupler 1320, controller 1316 and light source 1322 perform aspect of the present invention as illustrated in FIG. 8 or FIG. 11.

Wheel assembly 1302 is connected to lower rear portion of frame 1308 and makes contact with and resides on top of a ground surface 1306. Wheel assembly 1304 is connected to lower front portion of frame 1308 and makes contact with and resides on top of ground surface 1306. Handle 1310 is connected to upper rear portion of frame 1308.

Switch 1312 is attached to handle 1310. Wire 1314 is connected between switch 1312 and controller 1316. Wire 1314 traverses down handle 1310, rear portion of frame 1308 and into coupler 1320. Wire 1318 traverses through wheel assembly 1302 and connects between coupler 1320 and controller 1316.

Controller 1316 is attached to wheel assembly 1302 is electrically connected to light source 1322. Light source 1322 is attached to wheel assembly 1302. Light source displays light 110.

Person may actuate switch 1312 to turn on and turn off the display of light 110. When switch 1312 is turned to ON state, a signal indicating the ON condition is transmitted along wire 1314 to coupler 1320. Signal is then transmitted from coupler to controller 1316. Controller is then enabled to transmit signal to light source 1322 for the transmission of an emitted light 1324 if the conditions are appropriate.

When switch 1312 is turned to off state, a signal indicating the off condition is transmitted along wire 1314 to coupler 1320. Signal is then transmitted from coupler to controller 1316. Controller is then disabled from transmitting signal to light source 1322 for the transmission of emitted light 1324.

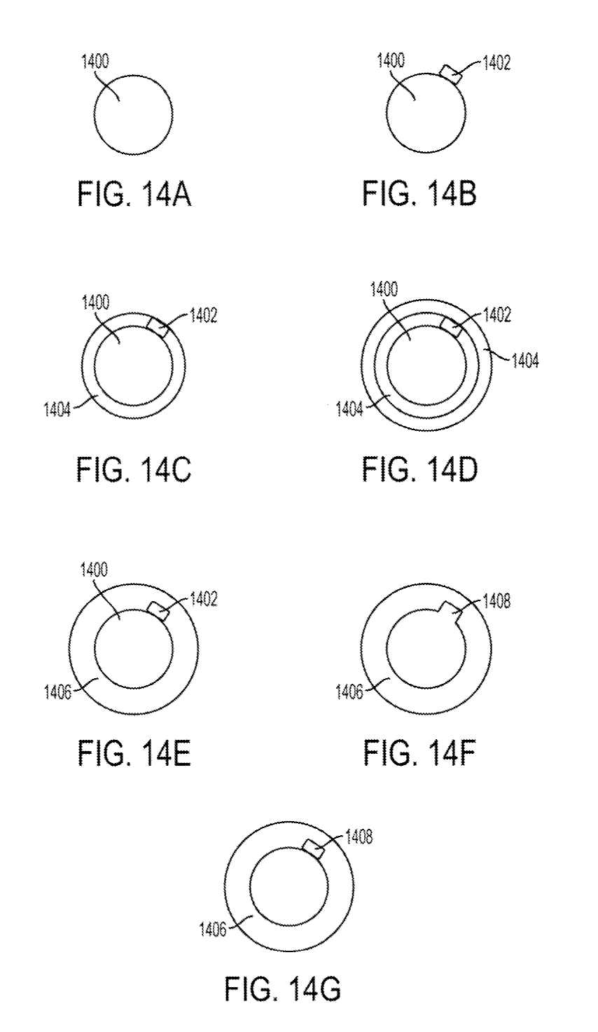

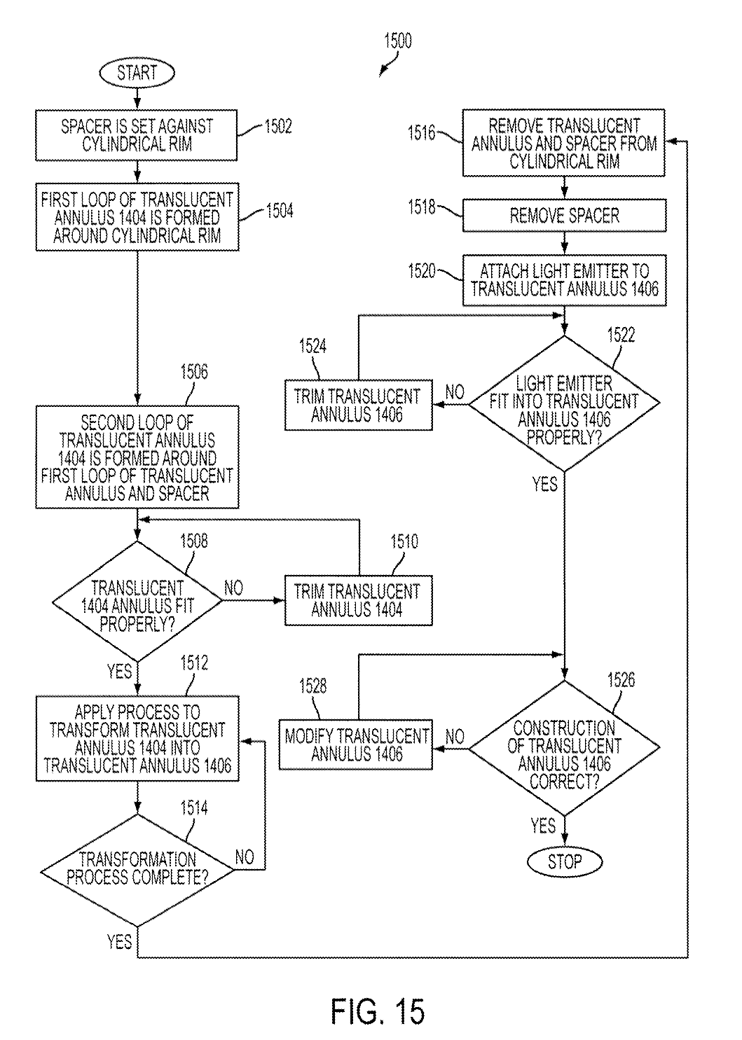

FIG. 13 illustrates an example embodiment of the present invention implemented in a stroller application where the ON/OFF state of the emitted light is controlled by a hard-wired switch. An example method of making an example wheel assembly in accordance with aspects of the present invention will now be described with reference to FIGS. 14A-G and FIG. 15.

FIG. 14A-G illustrates stages of development of an example wheel assembly as illustrated in FIGS. 1-2, in accordance with an aspect of the present invention. FIG. 15 is a flow chart describing an example method of fabricating the example wheel assembly as illustrated in FIGS. 1-2, in accordance with an aspect of the present invention.

A cylindrical rim 1400, as illustrated in FIG. 14A, has a spacer 1402 set against cylindrical rim 1400, as illustrated in FIG. 14B (S1502). Spacer 1402 functions to reserve a space or act as a placeholder in lieu of light source 108 in order to prevent light source 108 from being damaged from applied processes. If known tire making methods are not destructive to light source 108, then light source 108 itself may be used in place of spacer 1402 in FIG. 14C-E. The dimensions of spacer 1402 are similar to the dimensions of light source 108.

A first loop of a translucent annulus 1404 is formed or placed around the outside perimeter of cylindrical rim 1400, except where spacer 1402 is located, as illustrated in FIG. 14C (S1504) Translucent annulus 1404 is of sufficient length to support forming multiple iterations of placement around the outside perimeter of cylindrical rim 1400.

A second loop of translucent annulus 1404 is formed or placed around the outside perimeter of the first loop of translucent annulus 1404 and spacer 1402 as illustrated in FIG. 14D (S1506).

Then it is determined if translucent annulus 1404 has a proper fit as illustrated in FIG. 15 (S1508). If it is determined that translucent annulus 1404 does not have a proper fit, then it is trimmed until it has a proper fit as illustrated in FIG. 15 (S1510).

After translucent annulus 1404 has a proper fit, a transforming process is applied to the combined cylindrical rim 1400, spacer 1402 and translucent annulus 1404 such as, but not limited to, heat, pressure and/or chemical in order to fabricate a translucent annulus 1406 as illustrated in FIG. 14E. The applied process transforms the first loop of translucent annulus 1404 and the second loop of translucent annulus 1404 into translucent annulus 1406 (S1512).

Then it is determined if the applied transformation process is complete (S1514). If it is determined the transformation process is not complete, then the transformation process is applied again (S1512).

After the transformation process has been completed, translucent annulus 1406 and spacer 1402 are then removed from cylindrical rim 1400 (S1516). At this point spacer 1402 is removed from translucent annulus 1406 leaving a space 1408, as illustrated in FIG. 14F (S1518).

Light source 108 is then inserted into space 1408 of translucent annulus 1406, as illustrated in FIG. 14G (S1520).

FIG. 14A-G illustrates an example method for constructing an embodiment of the present invention where a spacer is inserted prior to applying transformation processes and is later removed and replaced by a light source after application of the transformation process. FIG. 15 illustrates a flow chart of the example method as illustrated in FIG. 14A-G for fabricating an embodiment of the present invention.

FIG. 15 illustrates an example method 1500 using the elements of FIG. 14A-G for constructing a translucent annulus with an embedded light source.

Method 1500 starts when spacer 1402 is set against cylindrical rim 1400 as illustrated in FIG. 14B (S1502).

Then the first loop of translucent annulus 1404 is formed or placed around cylindrical rim 1400, except where spacer 1402 is located as illustrated in a FIG. 14C (S1504).

Then a second loop of translucent annulus 1404 is formed or placed around the first loop of translucent annulus 1404 and spacer 1402, as illustrated in FIG. 14D (S1506).

Then translucent annulus 1404 is analyzed to determine if it has proper fit (S1508). If not, then translucent annulus 1404 is trimmed (S1510).

Once it is determined translucent annulus 1404 has a proper fit, a process is applied in order to transform translucent annulus 1404 into translucent annulus 1406 as illustrated in a FIG. 14E (S1512). This transforming process can include, but is not limited to, heat, pressure and/or chemical.

Then it is determined if the transformation process of converting translucent annulus 1404 into translucent annulus 1406 is successful or has been completed (S1514). If the process is not successful complete, then the process is applied once again (S1512).

Once the transformation process has been determined to be complete, translucent annulus 1406 and spacer 1402 are removed from cylindrical rim 1400 as illustrated in and FIG. 14F (S1516).

Then spacer 1402 is removed from translucent annulus 1406 as illustrated in FIG. 14F (S1518).

Then light source 108 is attached to translucent annulus 1406 as illustrated in FIG. 14G (S1520).

Then it is determined if light source 108 has a proper fit to translucent annulus 1406 (S1522). If the light source 108 does not fit properly, then translucent annulus 1406 is trimmed (S1524).

Once it is determined that light source 108 properly fits into translucent annulus 1406, the construction of translucent annulus 1406 and embedded light source 108 are verified for correctness (S1526).

If construction of translucent annulus 1406 and embedded light source 108 is not correct, then the translucent annulus 1406 and/or light source 108 are modified (S1528).

Once the construction of translucent annulus 1406 and light source 108 are determined to be correct method 1500 stops.

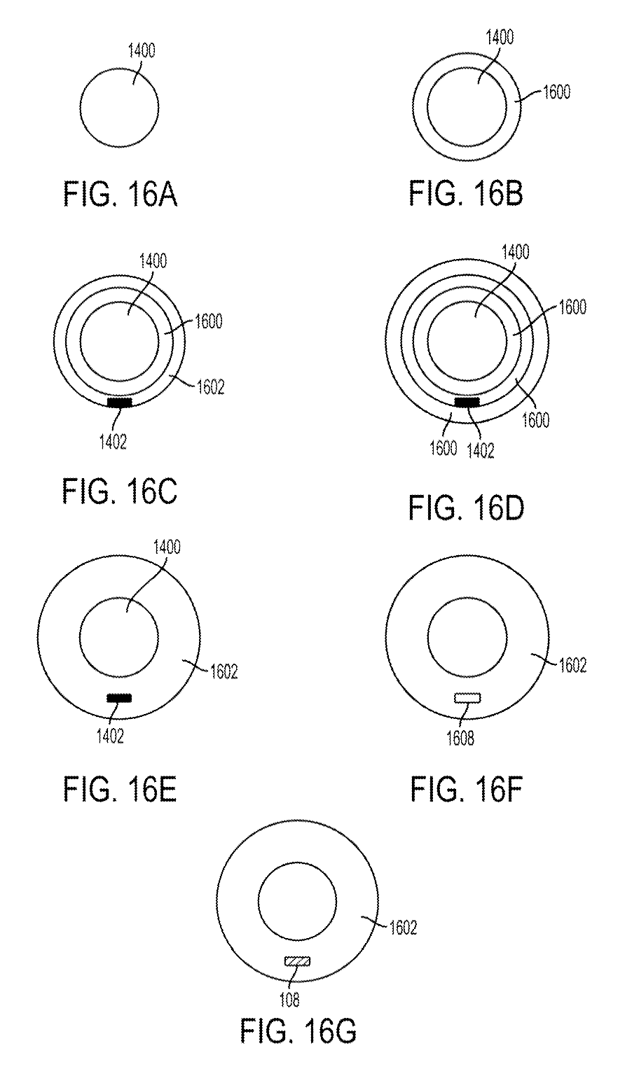

FIG. 15 illustrates a flow chart of the example method as illustrated in FIG. 14A-G for fabricating an embodiment of the present invention. FIG. 16A-G illustrates an example method for constructing an embodiment of the present invention.

FIG. 16A-G illustrates an example method for constructing a translucent annulus with an embedded light source as illustrated in FIG. 3, in accordance with an aspect of the present invention.

Components used for constructing a translucent annulus by this example method include a translucent annulus 1600 and light source 108.

The outside perimeter of cylindrical rim 1400, as illustrated in FIG. 16A, is surrounded by a first loop of translucent annulus 1600 as illustrated in FIG. 16B.

A second loop of translucent annulus 1600 and spacer 1402 are then formed or placed around the outside perimeter of the first loop of translucent annulus 1600, as illustrated in FIG. 16C. Spacer 1402 functions to reserve a space or act as a placeholder in lieu of light source 108 in order to prevent light source 108 from being damaged from applied processes. If the transforming process of this method is not destructive to light source 108, then light source 108 may be used in place of spacer 1402 in FIG. 16C-F. The dimensions of spacer 1402 are similar to the dimensions of light source 108.

A third loop of translucent annulus 1600 is then placed or formed around the outside perimeter of the second loop of translucent annulus 1600 and spacer 1402, as illustrated in FIG. 16D.

A transforming process is applied to the combined cylindrical rim 1400, translucent annulus 1600 and spacer 1402 such as, but not limited to, heat, pressure and/or chemical in order to fabricate a translucent annulus 1602 as illustrated in FIG. 16E.

Translucent annulus 1602 and spacer 1402 are then removed from cylindrical rim 1400 leaving translucent annulus 1602 with a space 1604, as illustrated in FIG. 16F.

Light source 108 is then attached to translucent annulus 1602 in void area provided by space 1604, as illustrated in FIG. 16G.

FIG. 16A-G illustrates an example method for constructing a translucent annulus with an embedded light source as illustrated in FIG. 3, in accordance with an aspect of the present invention.

In some embodiments of the present invention, it might be desirable to dispose a plurality of light sources within a translucent annulus. A plurality of light sources might provide improved illumination over a single light source. Furthermore, a plurality of light sources might provide improvements related to aesthetics and redundancy.

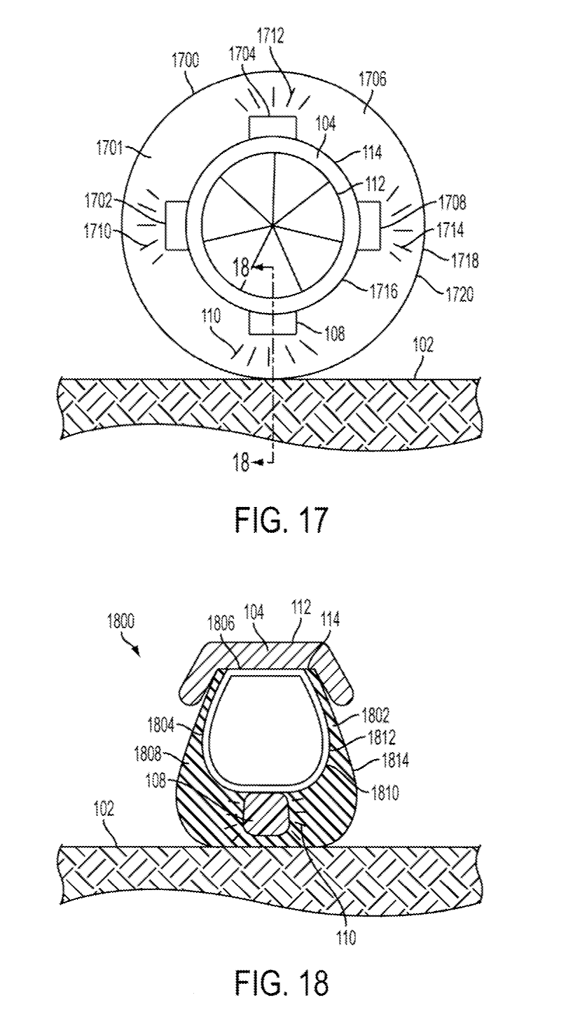

FIG. 17 illustrates an example wheel assembly 1700 with a plurality of light sources, in accordance with an aspect of the present invention.

Wheel assembly 1700 includes wheel rim 104 and a tire 1701. Tire 1701 has a translucent annulus 1706, light source 108, a light source 1702, a light source 1704 and a light source 1708. Translucent annulus 1706 has an inner radius 1716 and a periphery 1718, which includes an outer radius 1720.

Tire 1701 is mounted onto wheel rim 104 such that inner radius 1716 of translucent annulus 1706 contacts outer radius 114 of wheel rim 104. In this example, light source 108, 1702, 1704 and 1708 are adjacent to wheel rim 104. Outer radius 1720 of translucent annulus 1706 makes contact with and resides on top of ground surface 102.

Light source 108, 1702, 1704 and 1708 are operable to emit light 110, a light 1710, a light 1712 and a light 1714, respectively. Light 110, 1710, 1712 and 1714 may be any predetermined color, i.e., frequency, frequency band or combination of frequencies. Translucent annulus may be clear or have a predetermined color. In some embodiments, light 110, 1710, 1712 and 1714 are the same color as translucent annulus 106. In other embodiments, light 110, 1710, 1712 and 1714 are a different color as translucent annulus 1706. In some embodiments light 110, light 1710, light 1712 and light 1714 are of a different color. Since translucent annulus 1706 is translucent, light 110, 1710, 1712 and 1714 traverse through translucent annulus 1706 and eventually out through periphery 1718. Light 110, 1710, 1712 and 1714 may then seen to indicate a presence of wheel assembly 1700, and hence an associated wheeled device. Light 110, 1710, 1712 and 1714 may be white or may be a predetermined color.

In this embodiment four light sources are disposed within wheel assembly 1700, but the number of possible light sources disposed within the present invention is not limited.

Light source 108, 1702, 1704 and 1708 may be configured as, but are not limited to, any of the example embodiments as illustrated in FIGS. 7-11. Each light source may have its own individual configuration as depicted in FIGS. 7-11 or the circuitry of FIGS. 7-11 may be shared or not shared by the various light sources for each light source. For example light source 108, 1702, 1704 and 1708 may share the same sensor but have individual threshold detectors and timing controllers. Furthermore, the light sources may have varying sensors. For example, one light source might be associated with a pressure sensor, a second light source associated with a motion sensor and a third light source associated with an illumination sensor.

Furthermore, the timing for display of light from light source 108, 1702, 1704 and 1708 may be synchronized such that the light sources are not illuminated simultaneously. For example, consider wheel assembly 1700 when it is rotating. Each respective sensor for each light source may be configured to generate a signaling condition when a light source comes in close contact with ground surface 102. The respective timing for illuminating each light source would correspond to ¼ of the time it takes for wheel assembly 1700 to complete one rotation.

The example method of fabricating the present invention as depicted in FIGS. 14-15 may also be used to manufacture the example of the present invention as illustrated in FIG. 17. For fabricating the example of the present invention illustrated in FIG. 17, multiple spacers would be provided instead of a single spacer as illustrated in FIG. 14-15s and multiple light sources would be disposed instead of a single light source as depicted in FIG. 14-15s.

In the example wheel assemblies discussed above with reference to FIGS. 1-6 and 17, a tire in accordance with an aspect of the present invention is disposed directly on a wheel rim. In other embodiments, a tire in accordance with an aspect of the present invention may not be disposed directly on a wheel rim. More specifically, in other embodiments, the wheel assembly may include an inflatable inner tube that is disposed on the wheel rim. In these embodiments, a tire in accordance with an aspect of the present invention is disposed on the inflatable inner tube. These embodiments with be described in greater detail with reference to FIG. 18.

Another example embodiment will now be described with reference to FIG. 18. FIG. 18 illustrates a cross-sectional view of another example wheel assembly 1800 in accordance with an aspect of the present invention.

As illustrated in the figure, wheel assembly 1800 includes wheel rim 104 and a tire 1802. Tire 1802 includes an inflatable inner tube 1804, a translucent annulus portion 1808 and light source 108. Inflatable inner tube 1804 has an inner radial surface 1806 and a peripheral surface 1810. Translucent annulus portion 1808 has an inner peripheral surface 1812 and an outer peripheral surface 1814.

Tire 1802 is mounted onto wheel rim 104 such that inner radial surface 1806 of inflatable inner tube 1804 contacts outer radius 114 of wheel rim 104. Translucent annulus portion 1808 surrounds inflatable inner tube 1804 such that inner peripheral surface 1812 of translucent annulus portion 1808 contacts peripheral surface 1810 of inflatable inner tube 1804.

In this example embodiment, inflatable inner tube 1804 may be any known type of inflatable inner tube.

In some embodiments, light 110 is the same color as translucent annulus portion 1808. In other embodiments, light 110 is a different color as translucent annulus portion 1808. Since translucent annulus portion 1808 is translucent, light 110 traverses through translucent annulus portion 1808 and eventually out through outer peripheral surface 1812. Light 110 may then be seen to indicate a presence of wheel assembly 1800, and hence an associated wheeled device.

In this example embodiment, light source 108 is disposed within translucent annulus potion 1808 so as to contact peripheral surface 1810 of inflatable inner tube 1804. In some embodiments, light source 108 disposed within translucent annulus potion 1808 so as to spaced from peripheral surface 1810.

In this example embodiment, inflatable inner tube 1804 and translucent annulus potion 1808 are distinct elements. Accordingly, in the event that one of inflatable inner tube 1804 or translucent annulus portion 1808 becomes damaged, only the damaged piece may be replaced. In some embodiments, inflatable inner tube 1804 and translucent annulus potion 1808 are a unitary element.

The present invention includes a device for illumination of a translucent annulus for applications related to devices with tires and wheels. Non-limiting examples of applications for the present invention include bicycles, strollers, roller skates and automobile tires. The present invention allows for disposing a light source or light sources within a translucent annulus. The operation of the light source(s) may be controlled with respect to many different types of phenomena. Non-limiting examples of these phenomena include, pressure, motion, velocity, acceleration and illumination. A switch may be provided for enabling and inhibiting the illumination of the light source(s). Furthermore, a method is presented for fabricating the present invention where the translucent annulus is formed about a cylindrical rim and a spacer or spacers. After formation of the translucent. annulus, the spacer or spacers is/are removed and replaced with a light source or light sources.

The foregoing description of various preferred embodiments of the invention have been presented for purposes of illustration and description. It is not intended to be exhaustive or to limit the invention to the precise forms disclosed, and obviously many modifications and variations are possible in light of the above teaching. The exemplary embodiments, as described above, were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed as new and desired to be protected by Letters Patent of the United States is:

1. A device for use with a wheel having an outer radius, said device comprising:
a translucent annulus having an inner radial surface and being operable to surround the wheel such that said inner radial surface contacts the outer radius; and
a light source disposed within said translucent annulus and being operable to emit light into said translucent annulus.

2. The device of claim 1,
wherein said light source comprises a switch having an OFF state and an ON state,
wherein said light source is operable to emit a first amount of light through said translucent annulus when said switch is in the ON state, and
wherein said light source is operable to emit a second amount of light through said translucent annulus when said switch is in the OFF state.

3. The device of claim 2, wherein said light source is operable to emit the first amount of light through said translucent annulus for a predetermined period after said switch is switched from the ON state to the OFF state.

4. The device of claim 2, wherein said light source is operable to emit a zero amount of light through said translucent annulus when said switch is in the OFF state.

5. The device of claim 2, wherein said switch comprises a pressure sensitive switch operable to switch from the ON state to the OFF state upon a change in pressure.

6. The device of claim 2, further comprising a second switch, operable to switch said light source from the ON state to the OFF state based on a switching signal.

7. The device of claim 6, further comprising:
an input line in electrical connection with said second switch and operable to receive the switching signal; and
an actuator in electrical connection with said input line and operable to provide the switching signal upon actuation.

8. The device of claim 6, further comprising:
a receiver in electrical connection with said second switch and operable to receive the switching signal; and
an actuator operable to transmit the switching signal to said receiver upon actuation.

9. The device of claim 1, wherein said light source comprises a power source.

10. The device of claim 1, further comprising a power source in electrical connection with said light source and operable to provide power to said light source.

11. The device of claim 1,
wherein said translucent annulus has a first color, and
wherein said light source is operable to emit light of a second color.

12. The device of claim 11, wherein the first color is different from the second color.

13. The device of claim 1, wherein said translucent annulus comprises an inner annulus portion and an outer annulus portion.

14. The device of claim 13,
wherein said inner annulus portion comprises said inner radial surface and a peripheral surface,
wherein said outer annulus portion comprises an inner peripheral surface and an outer peripheral surface,
wherein said inner peripheral surface surrounds said peripheral surface, and
wherein said light source is disposed within said inner annulus portion.

15. The device of claim 14,
wherein said inner annulus portion comprises a first material,
wherein said outer annulus portion comprises a second material, and
wherein said first material is different from said second material.

16. The device of claim 1,
wherein said light source comprises a switch having an OFF state and an ON state,
wherein said light source is operable to emit a first amount of light through said translucent annulus when said switch is in the ON state,
wherein said light source is operable to emit a second amount of light through said translucent annulus when said switch is in the OFF state,
wherein said translucent annulus has a first color,
wherein said light source is operable to emit light of a second color,
wherein said inner annulus portion comprises said inner radial surface and a peripheral surface,
wherein said outer annulus portion comprises an inner peripheral surface and an outer peripheral surface,
wherein said inner peripheral surface surrounds said peripheral surface,
wherein said light source is disposed within said inner annulus portion,
wherein said inner annulus portion comprises a first material,
wherein said outer annulus portion comprises a second material, and
wherein said first material is different from said second material.

17. A method comprising:
disposing a spacer on a cylindrical rim;
forming a translucent annulus around the cylindrical rim so as to cover the spacer;
removing the translucent annulus and covered spacer from the cylindrical rim;
removing the covered spacer from the translucent annulus to provide a space within the translucent annulus; and
disposing a light source into the space within the translucent annulus.

18. The method of claim 17, wherein said forming a translucent annulus around the cylindrical rim so as to cover the spacer comprises disposing a plurality of layers of translucent material around the cylindrical rim and the spacer, and heating the plurality of layers of translucent material.

19. A method comprising:
forming a translucent annulus around a cylindrical rim;
disposing a spacer within the translucent annulus;
removing the translucent annulus and spacer from the cylindrical rim;
removing the spacer from the translucent annulus to provide a space within the translucent annulus; and
disposing a light source into the space within the translucent annulus.

20. The method of claim 19, wherein said forming a translucent annulus around a cylindrical rim comprises disposing a plurality of layers of translucent material around the cylindrical rim and heating the plurality of layers of translucent material.
